(19) United States
(12) Patent Application Publication
(10) Pub. No.: US 2014/0250456 A1
(43) Pub. Date: Sep. 4, 2014

(54) CONCURRENT SERVICE ALERTS DURING ACTIVE COMMUNICATION SESSIONS

(71) Applicant: QUALCOMM INCORPORATED, San Diego, CA (US)

(72) Inventors: Vasanth Kumar Ramkumar, San Diego, CA (US); Srinivasan Rajagopalan, San Diego, CA (US); Praveen N. Kona, San Diego, CA (US); Pratik Kotkar, San Diego, CA (US); Ashish S. Iyer, San Diego, CA (US)

(73) Assignee: QUALCOMM Incorporated, San Diego, CA (US)

(21) Appl. No.: 13/783,091

(22) Filed: Mar. 1, 2013

(51) Int. Cl. H04N 21/81; H04N 21/435; H04N 21/61

(52) U.S. Cl. CPC H04N 21/814; H04N 21/6181; H04N 21/435
USPC 725/33

(57) ABSTRACT

Various aspects of the present disclosure for wireless communication may intelligently present a concurrent communication session to a user while the user's user equipment (UE) is streaming and/or presenting an original communication session. Example aspects may receive streaming communication content at a mobile device during an active communication session, present the streaming communication content at the mobile device, receive a concurrent service indication at the mobile device during the active communication session, and the concurrent service (or notification thereof) at the mobile device while concurrently streaming the communication content.

### BACKGROUND

1. Field

Aspects of the present disclosure relate generally to wireless communication systems, and more particularly, to concurrent communication services during other active wireless communication sessions.

2. Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations that can support communication for a number of user equipments (UEs), also referred to as mobile entities. A UE may communicate with a base station via a downlink and an uplink. The downlink (or forward link) refers to the communication link from the base station to the UE, and the uplink (or reverse link) refers to the communication link from the UE to the base station. As used herein, a “base station” means an eNode B (eNB), a Node B, a Home Node B, or similar network component of a wireless communications system.

The 3rd Generation Partnership Project (3GPP) Long Term Evolution (LTE) represents a major advance in cellular technology as an evolution of Global System for Mobile communications (GSM) and Universal Mobile Telecommunications System (UMTS). The LTE physical layer (PHY) provides a highly efficient manner to convey both data and control information between base stations, such as an evolved Node Bs (eNBs), and mobile entities, such as UEs. In prior applications, a method for facilitating high bandwidth communication for multimedia has been single frequency network (SFN) operation. SFNs utilize radio transmitters, such as, for example, eNBs, to communicate with subscriber UEs. In unicast operation, each eNB is controlled so as to transmit signals carrying information directed to one or more particular subscriber UEs. The specificity of unicast signaling enables person-to-person services such as, for example, voice calling, text messaging, or video calling.

Recent LTE versions support eMBMS in the LTE air interface to provide the video streaming and file download broadcast delivery. For example, video streaming service is expected to be transported by the DASH (Dynamic Adaptive Streaming using HTTP) protocol over FLUTE (File Delivery over Unidirectional Transport) as defined in IETF RFC 3926 over UDP/IP packets. File download service is transported by FLUTE over UDP/IP protocols. Both high layers over IP are processed by the LTE broadcast channels in PHY and L2 (including MAC and RLC layers). However, such transport includes multiple inefficiencies which are not currently addressed in the communications industry.

Among these inefficiencies is an inability to intelligently send and receive concurrent communication sessions during an active communication session. For example, commercial mobile alert system (CMAS) and Earthquake and Tsunami warning system (ETWS) are features that help service providers, who choose to participate, to send emergency alerts users who have ETWS/CMAS capable handsets. In current ETWS/CMAS capable handsets, there are no systems or methods that can determine the importance of an alert, while the UE is streaming active eMBMS content. Further, there are no systems or methods that can choose from various ways of conveying the emergency alert and content to a user, while the UE is streaming active eMBMS content.

### SUMMARY

Various aspects of the present disclosure are directed to a method for wireless communication, which may include receiving streaming communication content at a mobile device during an active communication session. The example method may further comprise presenting the streaming communication content at the mobile device. Further still, the example method may receive an indication, at the mobile device during the active communication session, that a concurrent communication service is available and present notification of the available concurrent communication service at the mobile device while concurrently streaming the communication content.

In further aspects of the present disclosure, a method for wireless communication may include streaming communication content, by user equipment (UE), and receiving, from a network service, concurrent content, wherein the receiving is concurrent with the streaming. Moreover, the example method may identify, while concurrently streaming the streaming content, a category associated with the concurrent content. Based on the identifying, the method may determine how to present the concurrent content to a user, wherein the identifying is concurrent with streaming the streaming content. Based on the determining, the example method may present the concurrent content to a user of the UE.

An example wireless device for wireless communication according to additional aspects of the present disclosure may include a computer processor that receives streaming content. The example wireless device may also have a display that presents the streaming content. The computer processor may also receive concurrent content, and the concurrent content may be received concurrently with the streaming content. Further the concurrent content may comprises an indication of a category associated with the concurrent content. The computer processor may also identify the category, and based on the category, the computer processor may determine how to present the concurrent content to a user. In this example, the display may present the concurrent content according to the computer processor's determination, and the display may also concurrently stream the streaming content and present the concurrent content.

Further aspects of the present disclosure are directed to a wireless communication system comprises means for receiving streaming content, and means for receiving concurrent content, wherein the receiving is concurrent with the receiving the streaming content. Aspects of a wireless communication system also include means for identifying, while concurrently receiving the streaming content, a category associated with the concurrent content. Based on the identifying, the example wireless communication system may include means for determining how to present the concurrent content to a user, wherein the identifying is concurrent with the streaming content. Further, based on the determining, the example wireless communication system may include means for presenting the concurrent content to a user of the UE.

An example non-transitory computer-readable medium according to additional aspects of the present disclosure is also disclosed herein having program code stored thereon, wherein the program code, when executed by a computer, causes the computer to present streaming content. The program code, when executed also causes the computer to receive concurrent content, wherein the receiving is concurrent with the streaming. The computer is further caused to identify, while concurrently streaming the streaming content, a category associated with the concurrent content. Based on the identifying, the computer is caused to determine how to present the concurrent content to a user, wherein the determination is determined concurrently with streaming the streaming content. Based on the determining, the computer is caused to present the concurrent content to a user of the UE.

The foregoing has outlined rather broadly the features and technical advantages of the present application in order that the detailed description that follows may be better understood. Additional features and advantages will be described hereinafter which form the subject of the claims. It should be appreciated by those skilled in the art that the conception and specific aspect disclosed may be readily utilized as a basis for modifying or designing other structures for carrying out the same purposes of the present application. It should also be realized by those skilled in the art that such equivalent constructions do not depart from the spirit and scope of the present application and the appended claims. The novel features which are believed to be characteristic of aspects, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present claims.

### BRIEF DESCRIPTION OF THE DRAWINGS

FIG. 1 is a block diagram conceptually illustrating an example of a telecommunications system.

FIG. 2 is a block diagram conceptually illustrating an example of a down link frame structure in a telecommunications system.

FIG. 3 is a block diagram conceptually illustrating a design of a base station/eNB and a UE configured according to one aspect of the present disclosure.

FIG. 4 is a diagram of a signaling frame illustrating an example of symbol allocation for unicast and multicast signals.

FIG. 5 is a diagram illustrating MBMS over a Single Frequency Network (MBSFN) areas within an MBSFN service area.

FIG. 6 is a block diagram illustrating components of a wireless communication system for providing or supporting MBSFN service.

FIG. 7 is a functional block diagram illustrating example blocks executed to implement one aspect of the present disclosure.

FIG. 8 is a functional block diagram illustrating example blocks executed to implement one aspect of the present disclosure.

FIG. 9 is a functional block diagram illustrating example blocks executed to implement one aspect of the present disclosure.

FIG. 10A is a block diagram conceptually illustrating an example of a UE operable to implement one aspect of the present disclosure.

FIG. 10B is a block diagram conceptually illustrating an example of a UE operable to implement one aspect of the present disclosure.

FIG. 10C is a block diagram conceptually illustrating an example of a UE operable to implement one aspect of the present disclosure.

FIG. 10D is a block diagram conceptually illustrating an example of a UE operable to implement one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), CDMA2000, etc. UTRA includes Wideband CDMA (WCDMA) and other variants of CDMA. CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

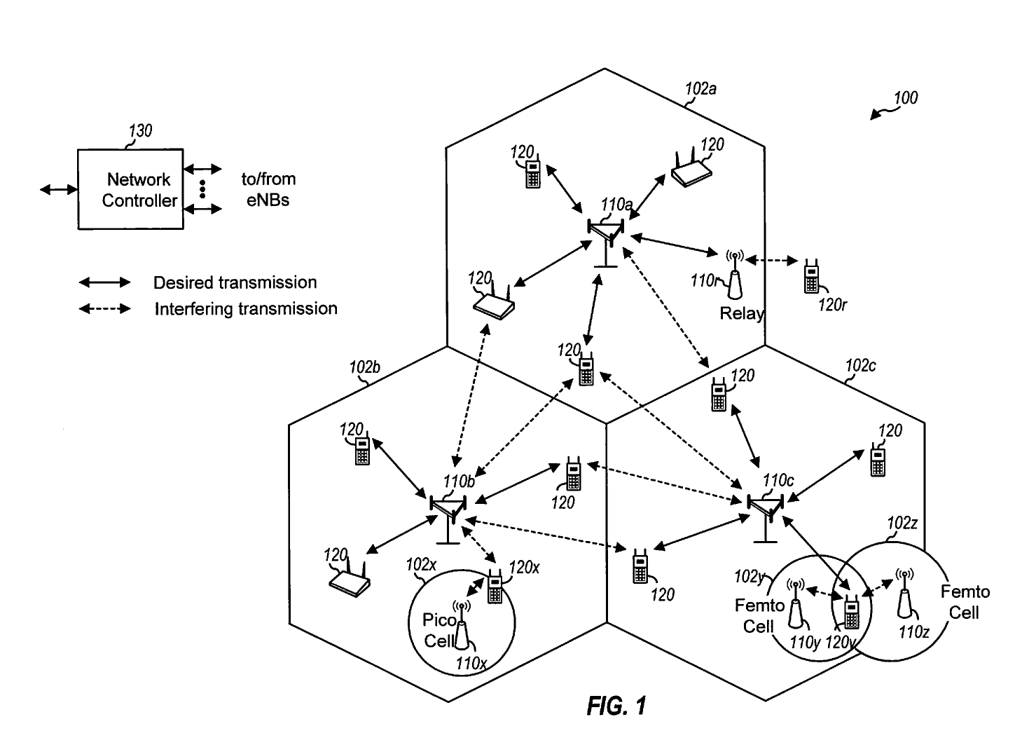

FIG. 1 shows a wireless communication network 100, which may be an LTE network. The wireless network 100 may include a number of eNBs 110 and other network entities. An eNB may be a station that communicates with the UEs and may also be referred to as a base station, a Node B, an access point, or other term. Each eNB 110a, 110b, 110c may provide communication coverage for a particular geographic area. In 3GPP, the term “cell” can refer to a coverage area of an eNB and/or an eNB subsystem serving this coverage area, depending on the context in which the term is used.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNB for a macro cell may be referred to as a macro eNB. An eNB for a pico cell may be referred to as a pico eNB. An eNB for a femto cell may be referred to as a femto eNB or a home eNB (HNB). In the example shown in FIG. 1, the eNBs 110a, 110b and 110c may be macro eNBs for the macro cells 102a, 102b and 102c, respectively. The eNB 110x may be a pico eNB for a pico cell 102x, serving a UE 120x. The eNBs 110y and 110z may be femto eNBs for the femto cells 102y and 102z, respectively. An eNB may support one or multiple (e.g., three) cells.

The wireless network 100 may also include relay stations 110r. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs. In the example shown in FIG. 1, a relay station 110r may communicate with the eNB 110a and a UE 120r in order to facilitate communication between the eNB 110a and the UE 120r. A relay station may also be referred to as a relay eNB, a relay, etc.

The wireless network 100 may be a heterogeneous network that includes eNBs of different types, e.g., macro eNBs, pico eNBs, femto eNBs, relays, etc. These different types of eNBs may have different transmit power levels, different coverage areas, and different impact on interference in the wireless network 100. For example, macro eNBs may have a high transmit power level (e.g., 20 Watts) whereas pico eNBs, femto eNBs and relays may have a lower transmit power level (e.g., 1 Watt).

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for both synchronous and asynchronous operation.

A network controller 130 may couple to a set of eNBs and provide coordination and control for these eNBs. The network controller 130 may communicate with the eNBs 110 via a backhaul. The eNBs 110 may also communicate with one another, e.g., directly or indirectly via wireless or wireline backhaul.

The UEs 120 may be dispersed throughout the wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, or other mobile entities. A UE may be able to communicate with macro eNBs, pico eNBs, femto eNBs, relays, or other network entities. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz, and there may be 1, 2, 4, 8 or 16 subbands for system bandwidth of 1.25, 2.5, 5, 10 or 20 MHz, respectively.

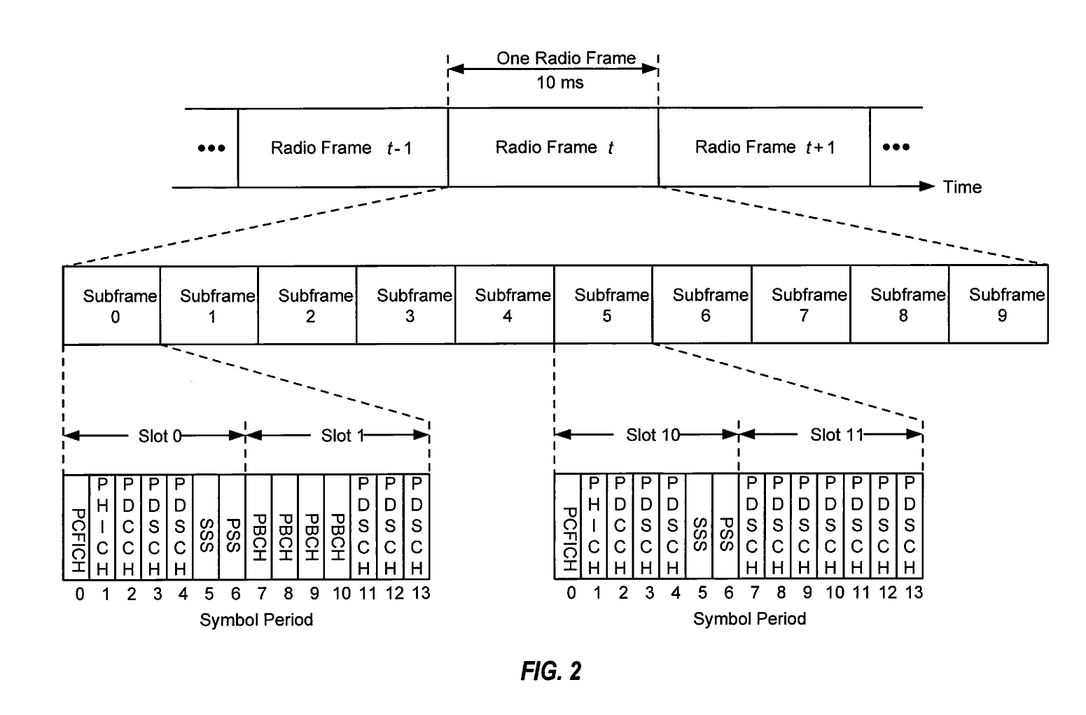

FIG. 2 shows a down link frame structure used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., 7 symbol periods for a normal cyclic prefix (CP), as shown in FIG. 2, or 6 symbol periods for an extended cyclic prefix. The normal CP and extended CP may be referred to herein as different CP types. The 2 L symbol periods in each subframe may be assigned indices of 0 through 2 L−1. The available time frequency resources may be partitioned into resource blocks. Each resource block may cover N subcarriers (e.g., 12 subcarriers) in one slot.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in only a portion of the first symbol period of each subframe, although depicted in the entire first symbol period in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 2, M=3. The eNB may send a Physical HARQ Indicator Channel (PHICH) and a Physical Downlink Control Channel (PDCCH) in the first M symbol periods of each subframe (M=3 in FIG. 2). The PHICH may carry information to support hybrid automatic retransmission (HARQ). The PDCCH may carry information on resource allocation for UEs and control information for downlink channels. Although not shown in the first symbol period in FIG. 2, it is understood that the PDCCH and PHICH are also included in the first symbol period. Similarly, the PHICH and PDCCH are also both in the second and third symbol periods, although not shown that way in FIG. 2. The eNB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNB may send the PSS, SSS and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 32 or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

A UE may be within the coverage of multiple eNBs. One of these eNBs may be selected to serve the UE. The serving eNB may be selected based on various criteria such as received power, path loss, signal-to-noise ratio (SNR), etc.

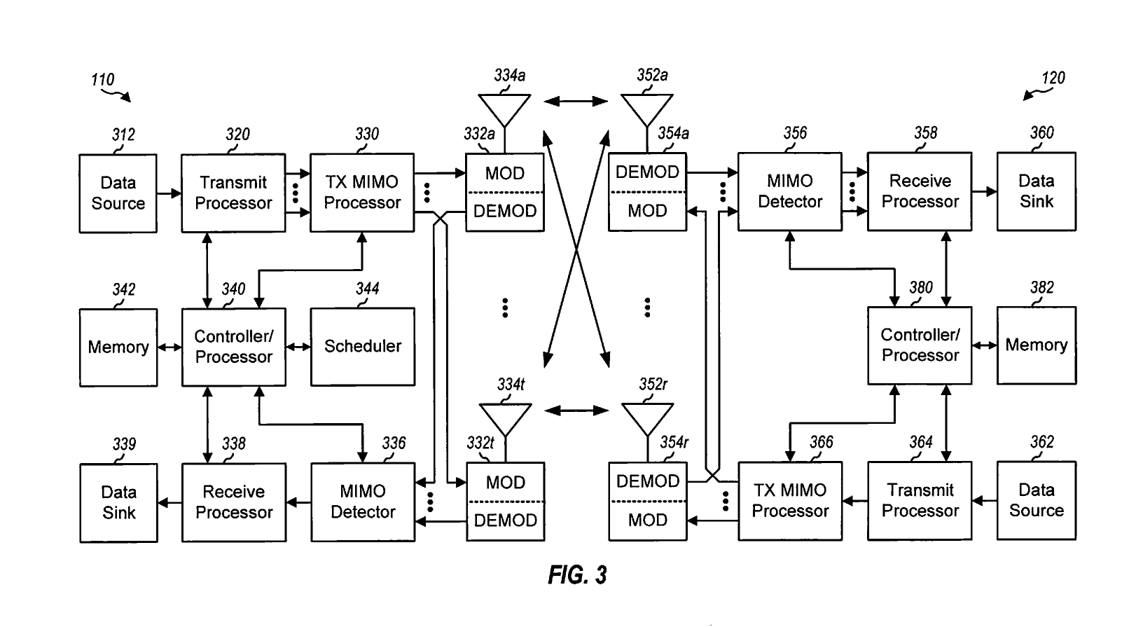

FIG. 3 shows a block diagram of a design of a base station/eNB 110 and a UE 120, which may be one of the base stations/eNBs and one of the UEs in FIG. 1. For a restricted association scenario, the base station 110 may be the macro eNB 110c in FIG. 1, and the UE 120 may be the UE 120y. The base station 110 may also be a base station of some other type. The base station 110 may be equipped with antennas 334a through 334t, and the UE 120 may be equipped with antennas 352a through 352r.

At the base station 110, a transmit processor 320 may receive data from a data source 312 and control information from a controller/processor 340. The control information may be for the PBCH, PCFICH, PHICH, PDCCH, etc. The data may be for the PDSCH, etc. The processor 320 may process (e.g., encode and symbol map) the data and control information to obtain data symbols and control symbols, respectively. The processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. Downlink signals from modulators 332a through 332t may be transmitted via the antennas 334a through 334t, respectively.

At the UE 120, the antennas 352a through 352r may receive the downlink signals from the base station 110 and may provide received signals to the demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all the demodulators 354a through 354r, perform MIMO detection on the received symbols if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The processor 364 may also generate reference symbols for a reference signal. The symbols from the transmit processor 364 may be precoded by a TX MIMO processor 366 if applicable, further processed by the modulators 354a through 354r (e.g., for SC-FDM, etc.), and transmitted to the base station 110. At the base station 110, the uplink signals from the UE 120 may be received by the antennas 334, processed by the demodulators 332, detected by a MIMO detector 336 if applicable, and further processed by a receive processor 338 to obtain decoded data and control information sent by the UE 120. The processor 338 may provide the decoded data to a data sink 339 and the decoded control information to the controller/processor 340.

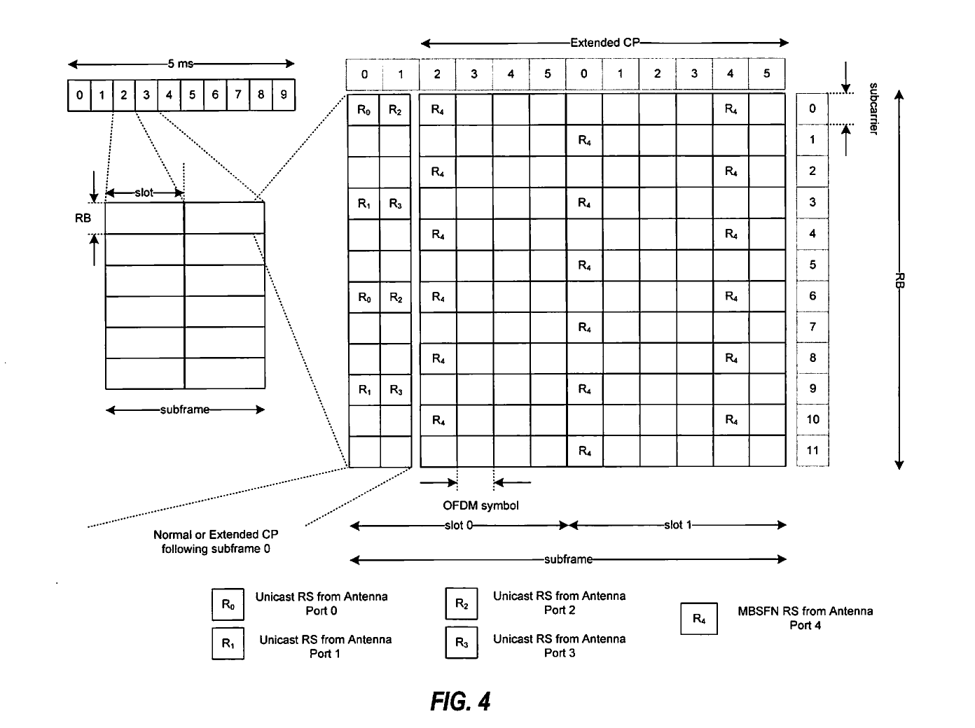

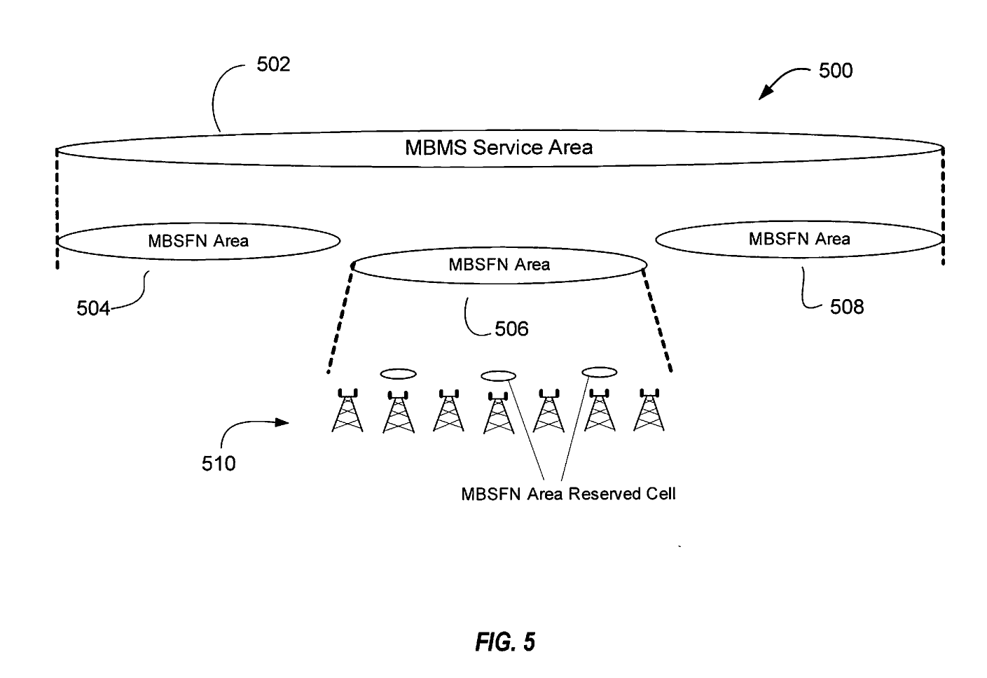

The controllers/processors 340 and 380 may direct the operation at the base station 110 and the UE 120, respectively. The processor 340 and/or other processors and modules at the base station 110 may perform or direct the execution of various processes for the techniques described herein. The processor 380 and/or other processors and modules at the UE 120 may also perform or direct the execution of the functional blocks illustrated in FIGS. 4 and 5, and/or other processes for the techniques described herein. The memories 342 and 382 may store data and program codes for the base station 110 and the UE 120, respectively. A scheduler 344 may schedule UEs for data transmission on the downlink and/or uplink.

In one configuration, the UE 120 for wireless communication includes means for detecting interference from an interfering base station during a connection mode of the UE, means for selecting a yielded resource of the interfering base station, means for obtaining an error rate of a physical downlink control channel on the yielded resource, and means, executable in response to the error rate exceeding a predetermined level, for declaring a radio link failure. In one aspect, the aforementioned means may be the processor(s), the controller/processor 380, the memory 382, the receive processor 358, the MIMO detector 356, the demodulators 354a, and the antennas 352a configured to perform the functions recited by the aforementioned means. In another aspect, the aforementioned means may be a module or any apparatus configured to perform the functions recited by the aforementioned means.

eMBMS and Unicast Signaling in Single Frequency Networks:

One technique to facilitate high bandwidth communication for multimedia has been single frequency network (SFN) operation. Particularly, Multimedia Broadcast Multicast Service (MBMS) and MBMS for LTE, also known as evolved MBMS (eMBMS) (including, for example, what has recently come to be known as multimedia broadcast single frequency network (MBSFN) in the LTE context), can utilize such SFN operation. SFNs utilize radio transmitters, such as, for example, eNBs, to communicate with subscriber UEs. Groups of eNBs can transmit information in a synchronized manner, so that signals reinforce one another rather than interfere with each other. In the context of eMBMS, the shared content is transmitted from multiple eNB's of a LTE network to multiple UEs. Therefore, within a given eMBMS area, a UE may receive eMBMS signals from any eNB(s) within radio range as part of the eMBMS service area or MBSFN area. However, to decode the eMBMS signal each UE receives Multicast Control Channel (MCCH) information from a serving eNB over a non-eMBMS channel. MCCH information changes from time to time and notification of changes is provided through another non-eMBMS channel, the PDCCH. Therefore, to decode eMBMS signals within a particular eMBMS area, each UE is served MCCH and PDCCH signals by one of the eNBs in the area.

In accordance with aspects of the subject of this disclosure, there is provided a wireless network (e.g., a 3GPP network) having features relating to single carrier optimization for eMBMS. eMBMS provides an efficient manner to transmit shared content from an LTE network to multiple mobile entities, such as, for example, UEs.

With respect a physical layer (PHY) of eMBMS for LTE Frequency Division Duplex (FDD), the channel structure may comprise time division multiplexing (TDM) resource partitioning between eMBMS and unicast transmissions on mixed carriers, thereby allowing flexible and dynamic spectrum utilization. Currently, a subset of subframes (up to 60%), known as multimedia broadcast single frequency network (MBSFN) subframes, can be reserved for eMBMS transmission. As such current eMBMS design allows at most six out of ten subframes for eMBMS.

An example of subframe allocation for eMBMS is shown in FIG. 4, which shows an existing allocation of MBSFN reference signals on MBSFN subframes, for a single-carrier case. Components depicted in FIG. 4 correspond to those shown in FIG. 2, with FIG. 4 showing the individual subcarriers within each slot and resource block (RB). In 3GPP LTE, an RB spans 12 subcarriers over a slot duration of 0.5 ms, with each subcarrier having a bandwidth of 15 kHz together spanning 180 kHz per RB. Subframes may be allocated for unicast or eMBMS; for example in a sequence of subframes labeled 0, 1, 2, 3, 4, 5, 6, 7, 8, and 9, subframes 0, 4, 5, and 9 may be excluded from eMBMS in FDD. Also, subframes 0, 1, 5, and 6 may be excluded from eMBMS in time division duplex (TDD). More specifically, subframes 0, 4, 5, and 9 may be used for PSS/SSS/PBCH/paging/system information blocks (SIBs) and unicast service. Remaining subframes in the sequence, e.g., subframes 1, 2, 3, 6, 7, and 8 may be configured as eMBMS subframes.

With continued reference to FIG. 4, within each eMBMS subframe, the first 1 or 2 symbols may be used for unicast reference symbols (RSs) and control signaling. A CP length of the first 1 or 2 symbols may follow that of subframe 0. A transmission gap may occur between the first 1 or 2 symbols and the eMBMS symbols if the CP lengths are different. In related aspects, the overall eMBMS bandwidth utilization may be 42.5% considering RS overhead (e.g., 6 eMBMS subframes and 2 control symbols within each eMBMS subframe). Known techniques for providing MBSFN RSs and unicast RSs typically involve allocating the MBSFN RSs on MBSFN subframes (as shown in FIG. 4), and separately allocating unicast RSs on non-MBSFN subframes. More specifically, as FIG. 4 shows, the extended CP of the MBSFN subframe includes MBSFN RSs but not unicast RSs. The present technology is not limited to the particular frame allocation scheme illustrated by FIGS. 2 and 4, which are presented by way of example, and not by way of limitation. A multicast session or multicast broadcast as used herein may use any suitable frame allocation scheme.

eMBMS Service Areas:

FIG. 5 illustrates a system 500 including an MBMS service area 502 encompassing multiple MBSFN areas 504, 506, 508, which themselves include multiple cells or base stations 510. As used herein, an “MBMS service area” refers to a group of wireless transmission cells where a certain MBMS service is available. For example, a particular sports or other program may be broadcast by base stations within the MBMS service area at a particular time. The area where the particular program is broadcast defines the MBMS service area. The MBMS service area may be made up of one or more “MBSFN areas” as shown at 504, 506 and 508. As used herein, an MBSFN area refers to a group of cells (e.g., cells 510) currently broadcasting a particular program in a synchronized fashion using an MBSFN protocol. An “MBSFN synchronization area” refers to a group of cells that are interconnected and configured in a way such that they are capable of operating in a synchronized fashion to broadcast a particular program using an MBSFN protocol, regardless of whether or not they are currently doing so. Each eNB can belong to only one MBSFN synchronization area, on a given frequency layer. It is worth noting that an MBMS service area 502 may include one or more MBSFN synchronization areas (not shown). Conversely, an MBSFN synchronization area may include one or more MBSFN areas or MBMS service areas. Generally, an MBSFN area is made up of all, or a portion of, a single MBSFN synchronization area and is located within a single MBMS service area. Overlap between various MBSFN areas is supported, and a single eNB may belong to several different MBSFN areas. For example, up to 8 independent MCCHs may be configured in System Information Block (SIB) 13 to support membership in different MBSFN areas. An MBSFN Area Reserved Cell or Base Station is a cell/base station within a MBSFN Area that does not contribute to the MBSFN transmission, for example a cell near a MBSFN Synchronization Area boundary, or a cell that that is not needed for MBSFN transmission because of its location.

eMBMS System Components and Functions:

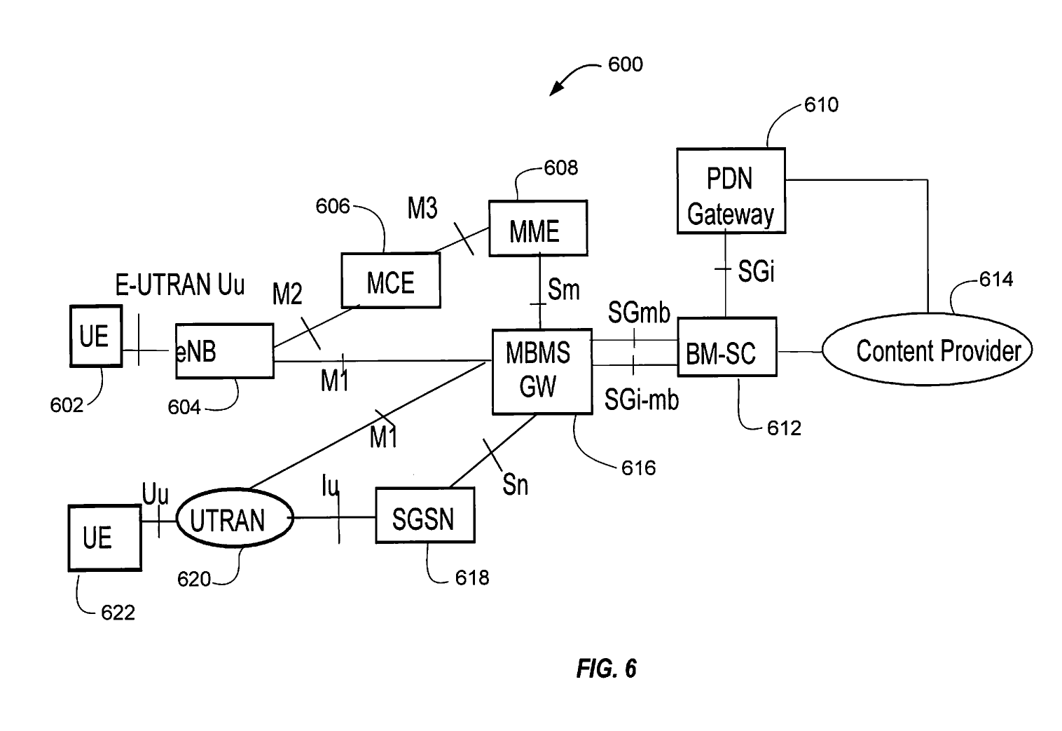

FIG. 6 illustrates functional entities of a wireless communication system 600 for providing or supporting MBSFN service. Regarding Quality of Service (QoS), the system 600 uses a Guaranteed Bit Rate (GBR) type MBMS bearer, wherein the Maximum Bit Rate (MBR) equals the GBR. These components are shown and described by way of example, and do not limit the inventive concepts described herein, which may be adopted to other architectures and functional distributions for delivering and controlling multicast transmissions.

The system 600 may include an MBMS Gate Way (MBMS GW) 616. The MBMS GW 616 controls Internet Protocol (IP) multicast distribution of MBMS user plane data to eNodeBs 604 via an M1 interface; one eNB 604 of many possible eNBs is shown. In addition, the MBMS GW controls IP multicast distribution of MBMS user plane data to UTRAN Radio Network Controllers (RNCs) 620 via an M1 interface; one UTRAN RNC 620 of many possible RNCs is shown. The M1 interface is associated to MBMS data (user plane) and makes use of IP for delivery of data packets. The eNB 604 may provide MBMS content to a user equipment (UE)/mobile entity 602 via an E-UTRAN Uu interface. The RNC 620 may provide MBMS content to a UE mobile entity 622 via a Uu interface. The MBMS GW 616 may further perform MBMS Session Control Signaling, for example MBMS session start and session stop, via the Mobility Management Entity (MME) 608 and Sm interface. The MBMS GW 616 may further provide an interface for entities using MBMS bearers through the SG-mb (user plane) reference point, and provide an interface for entities using MBMS bearers through the SGi-mb (control plane) reference point. The SG-mb Interface carries MBMS bearer service specific signaling. The SGi-mb interface is a user plane interface for MBMS data delivery. MBMS data delivery may be performed by IP unicast transmission, which may be a default mode, or by IP multicasting. The MBMS GW 616 may provide a control plane function for MBMS over UTRAN via a Serving General Packet Radio Service Support Node (SGSN) 618 and the Sn/Iu interfaces.

The system 600 may further include a Multicast Coordinating Entity (MCE) 606. The MCE 606 may perform an admission control function form MBMS content, and allocate time and frequency radio resources used by all eNBs in the MBSFN area for multi-cell MBMS transmissions using MBSFN operation. The MCE 606 may determine a radio configuration for an MBSFN Area, such as, for example, the modulation and coding scheme. The MCE 606 may schedules and control user plane transmission of MBMS content, and manage eMBMS service multiplexing, by determining which services are to be multiplexed in which Multicast Channel (MCH). The MCE 606 may participate in MBMS Session Control Signaling with the MME 608 through an M3 interface, and may provide a control plane interface M2 with the eNB 604.

The system 600 may further include a Broadcast-Multicast Service Center (BM-SC) 612 in communication with a content provider server 614. The BM-SC 612 may handle intake of multicast content from one or more sources such as the content provider 614, and provide other higher-level management functions as described below. These functions may include, for example, a membership function, including authorization and initiation of MBMS services for an identified UE. The BM-SC 612 may further perform MBMS session and transmission functions, scheduling of live broadcasts, and delivery, including MBMS and associated delivery functions. The BM-SC 612 may further provide service advertisement and description, such as advertising content available for multicast. A separate Packet Data Protocol (PDP) context may be used to carry control messages between a UE and BM-SC 612. The BM-SC 612 may further provide security functions such as key management, manage charging of content providers according to parameters such as data volume and QoS, provide content synchronization for MBMS in UTRAN and in E-UTRAN for broadcast mode, and provide header compression for MBSFN data in UTRAN. The BM-SC 612 may indicate session start, update and stop to the MBMS-GW 616 including session attributes such as QoS and MBMS service area.

The system 600 may further include a Multicast Management Entity (MME) 608 in communication with the MCE 606 and MBMS-GW 608. The MME 600 may provide a control plane function for MBMS over E-UTRAN. In addition, the MME may provide the eNB 604, 620 with multicast related information defined by the MBMS-GW 616. An Sm interface between the MME 608 and the MBMS-GW 616 may be used to carry MBMS control signaling, for example, session start and stop signals.

The system 600 may further include a Packet Data Network (PDN) Gate Way (GW) 610, sometimes abbreviated as a P-GW. The P-GW 610 may provide an Evolved Packet System (EPS) bearer between the UE 602 and BM-SC 612 for signaling and/or user data. As such, the P-GW may receive Uniform Resource Locator (URL) based requests originating from UEs in association with IP addresses assigned to the UEs. The BM-SC 612 may also be linked to one or more content providers via the P-GW 610, which may communicate with the BM-SC 612 via an IP interface.

Presently, during an active streaming communication session supported by the systems and methods described above, there is currently no elegant manner to begin a concurrent communication service or a notification thereof. For example, if a user is viewing streaming content on a mobile device, whether through unicast, broadcast, or multicast, any new concurrent services will break the current session and leave the user with a negative user experience. Thus, better handling of the beginning and notification of concurrent communications (for example service alerts) during an already active communication session is desired.

The already active communication session (e.g., the original communication service) can be any one of a unicast, broadcast, or multicast. An exemplary original communication service is streaming eMBMS content. Concurrent communication services are communications whose transmission may have begun after the original communication service started but nonetheless are being transmitted concurrently with the original communication service. A concurrent communication service may be of the same type of communication as the original communication (e.g., both communications may be an eMBMS, both may be a voice communications, both may be streaming audio or video communications, both may be streaming multimedia, etc.). Additionally or alternative, a concurrent communication service may be a different type of communication as compared to the original communication (e.g., the original communication may be streaming video while the concurrent communication may be an eMBMS, the original communication may be streaming multimedia while the concurrent communication may be streaming audio content).

One example of a concurrent communication is a Commercial Mobile Alert System (CMAS) communication and/or Earthquake and Tsunami Warning System (ETWS) communication. CMAS and ETWS are emergency communication systems that send emergency communications, for example, service alerts. It should be noted that other servicing entities are able to send alerts to participants that desire them, for example a service alert system operable to inform employees about company alerts (e.g., inclement weather causing an office to be closed for an amount of time). Service alerts from CMAS, ETWS, and others help service providers (who choose to participate) send emergency alerts to their users who have capable handsets. CMAS service alerts may be concurrently transmitted on SystemInformationBlock (SIB) 12, ETWS service alerts may be concurrently transmitted on SIB 11, and other service alerts could be established to transmit on other SIBs as is desired.

Concurrent communication services may be categorized, ranked, prioritized, classified, typed, and/or the like. For example, a emergency service alerts in CMAS may be categorized into one of three categories: (1) Presidential Alerts, including alert message issued by the President for local, regional, or national emergencies and may be considered the a highest priority alert; (2) Imminent Threat Alerts, including notification of emergency conditions, such as hurricanes or tornadoes, where there is an imminent threat to life or property and some immediate responsive action should be taken; and (3) Child Abduction Emergency/AMBER Alerts, including alerts related to missing or endangered children (and/or adults) due to an abduction or runaway situation. In another example, a service alert may be ranked into one of several categories: for example, Low, Intermediary, High, and Highest. It should be noted that any number of rankings and categories may be established as is desired. Further, the ranking may be a threshold wherein a service alert comprises a value (for example), and the value is compared to a threshold to determine the service alert's ranking (e.g., if x≧4, then the service alert is in the Imminent category, if x≧4, then the service alert is of type B, if x≧4, then the service type is Intermediary, etc.). Emergency communications as concurrent services may be categorized in this manner, while non-emergency services that become concurrent services may have other categories or types. Any number of categories, ranks, priorities, classifications, thresholds, types, and/or the like, can be used as is desired for emergency communications and/or non-emergency communications transmitted as concurrent services.

Classifying, ranking, categorizing, prioritizing, typing etc. concurrent communications helps a UE intelligently handle concurrent communications received during an active communication service because the UE receiving the concurrent communication can identify the classification, ranking, category, priority, type, etc. of the concurrent communication and intelligently present the concurrent communication, or notification thereof, to a user based on the identified classification, ranking, category, priority, type, etc. For example, a CMAS/ETWS alert can be intelligently conveyed to a user during active streaming of eMBMS content, wherein the manner of conveyance is based on the identified classification of the CMAS/ETWS alert.

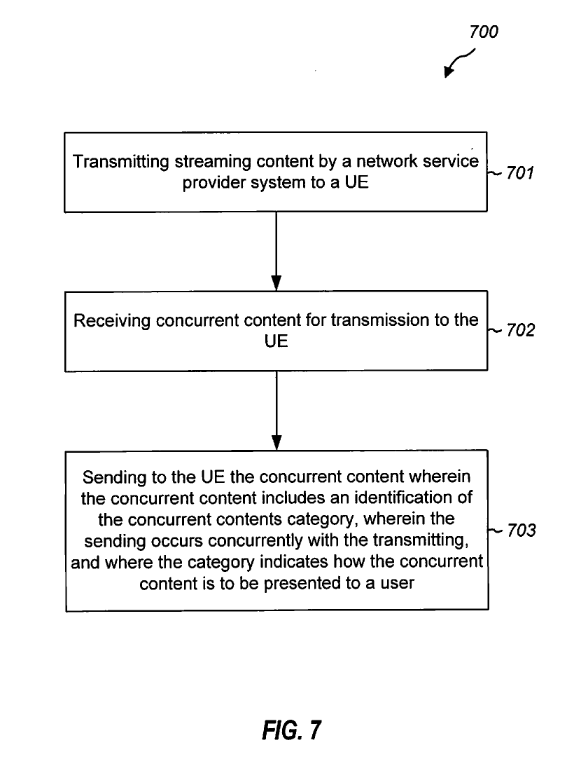

FIG. 7 illustrates an aspect of handling a concurrent communication service while transmitting an original communication service. Various aspects of the present disclosure provide for one or more computer processors of a network entity to transmit an original communication session to a UE, block 701. For example, a network entity may stream eMBMS content to a UE. At any point during the original communication session, the network entity may receive a concurrent communication service from a content providing entity 614, block 702. The network entity may receive the concurrent communication service at PDN Gateway 610 and/or BM-SC 612, and or the like. The concurrent communication service may be categorized, ranked, prioritized, classified, typed, and/or the like, as discussed above. In some examples, the content providing entity 614 will identify the concurrent communication service's category, rank, priority, classification, type, etc. For instance, a CMAS entity sending a service alert may identify the service alert's category as being Presidential, and information indicating the category may be included within or along with the service alert sent to the network provider. Additionally (or alternatively), a component of the network entity may independently identify or verify the alert's category, block 702. For example, MBMS GW 616 may analyze data included in a received concurrent communication service and identify and/or verify the category of a service alert. The independent identification or verification may be done if the service alert does not have an identifier therewith, and/or as a verification or authentication step to verify or authenticate the identification and/or verify or authenticate the source of the service alert.

After the network entity receives the concurrent communication service, one or more processors (e.g. MBMS GW 616) of the network entity will transmit the concurrent communication service to all appropriate UEs (e.g. UE 602 and 622) via eNB 604 and/or UTRAN 620. The transmission may be a separate transmission comprising some or all of the originally received transmission of the concurrent communication service, but could also be a relay of the originally received transmission of the concurrent communication service. Appropriate UEs may be those UEs which are identified by the content providing entity 614 as being appropriate to receive the concurrent communication service. The concurrent communication service may include destination information that identifies the appropriate UEs to receive the concurrent communication session. The network provider may have a list of the appropriate UEs or otherwise be able to identify the appropriate UEs. The appropriate UEs may be identifiable based on their geographical location, their subscription to a service, their recent historical activity, their long term historical activity, or any combination thereof. The network entity transmits the concurrent communication service to one or more UE concurrently with transmitting the original communication service to the one or more UE, block 703.

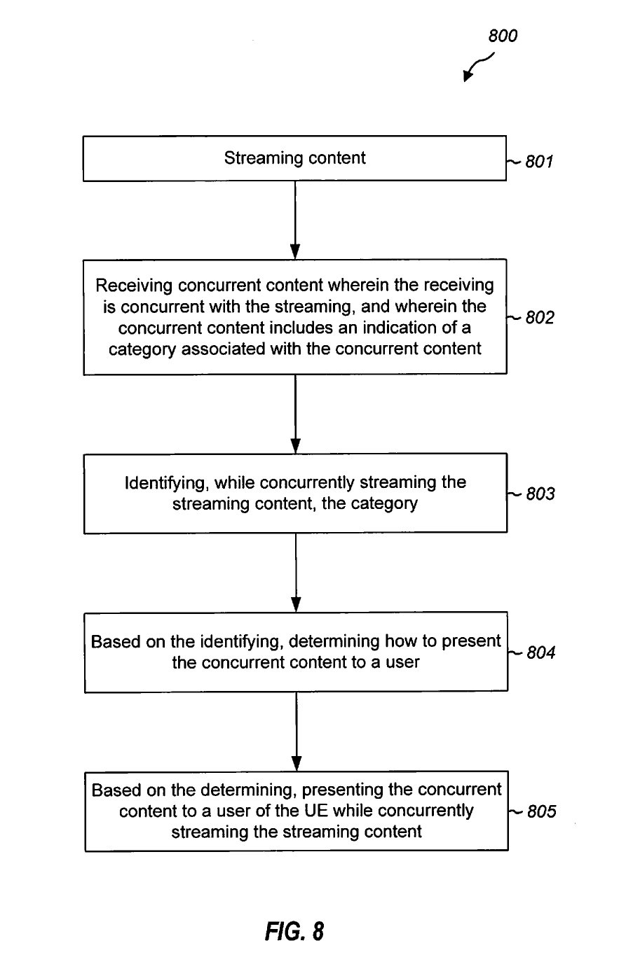

FIG. 8 shows aspects of a UE receiving a concurrent communication service while concurrently receiving an original communication service. Various aspects of the present disclosure provide for a UE to receive an original communication service from a network entity, block 801. For example, a UE may receive streaming eMBMS content from a network entity. The UE presents the original communication service to a user. For example, the UE may present streaming eMBMS content to a user through the user interface (e.g., display). While the UE is presenting the original communication service, the UE will concurrently receive at least one concurrent communication service from the same or a different network entity, block 802. The concurrent communication service may be in the form of a service alert. For example, while the UE displays streaming eMBMS content, the UE may receive a service alert which comprises a concurrent communication service. Alternatively, a service alert may not comprise the concurrently communication service, but rather, the service alert may comprise a notification of an available concurrent communication service.

The concurrent communication service and/or notification thereof may be categorized, ranked, prioritized, classified, typed, and/or the like, as discussed above. For example, the concurrent communication service may be categorized as Imminent. The UE may be operable to identify the concurrent communication service's category from the data the UE received from the network entity, block 803. For example, the UE may identify the concurrent communication service as being Imminent. Based on the concurrent communication service's identified category, the UE may determine how to present the concurrent communication service to the UE user, block 804. For example, based on the UE's identification of the concurrent communication service as being Imminent, the UE determines how to present the concurrent communication service to the user. Based on the determination of how to present the concurrent communication service to the user, the UE presents the concurrent communication service to the user in accordance with the determination, block 805. For example, the UE determines that Imminent concurrent communication services (or notifications thereof) are presented in a particular manner, and then presents the concurrent communication service (or notification thereof) in that particular manner.

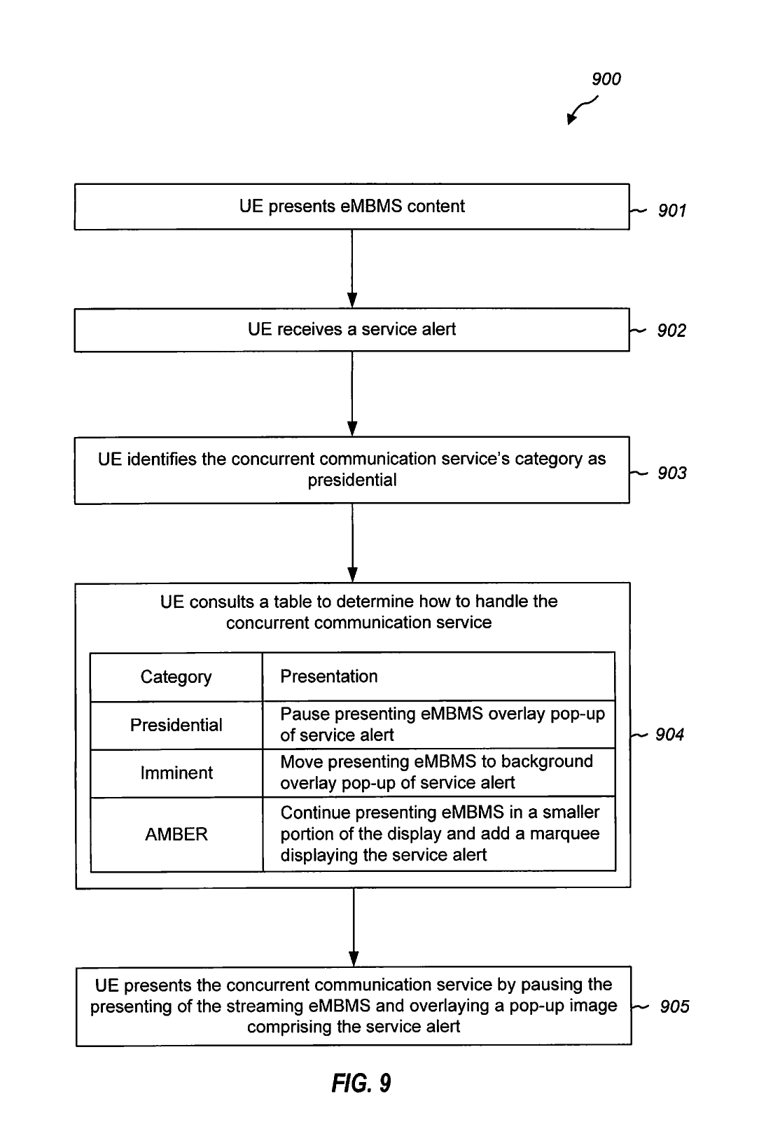

FIG. 9 shows an example of how a UE handles a service alert which is categorized as Presidential. In block 901, the UE is streaming and presenting eMBMS content. While presenting streaming eMBMS content, the UE receives a service alert, block 902. The UE identifies the category of the service alert based on information in the service alert, and in this example, the UE identifies the service alert as being Presidential, block 903. Using this identification, the UE determines how to present the service alert to the user. In this example, the UE consults a table which establishes how to handle various service alerts. After consulting this example table, the UE determines that Presidential service alerts are presented by pausing the presentation of streaming eMBMS content and displaying a pop-up comprising the service alert, block 904. Based on this determination, the UE presents the service alert by pausing the presentation of streaming eMBMS content and displaying a pop-up comprising the service alert, block 905. It should be noted that the table in this example is merely exemplary such that the number and type of categories could be changed as desired as well as the ways of presenting the alerts.

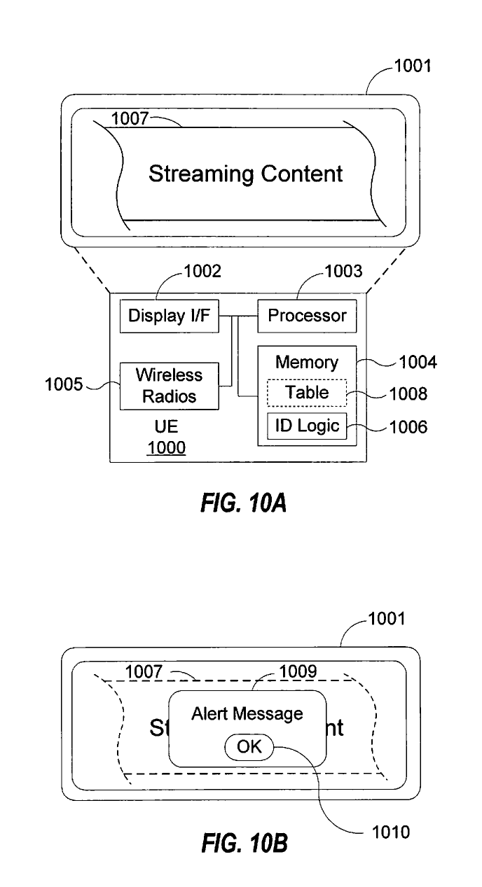

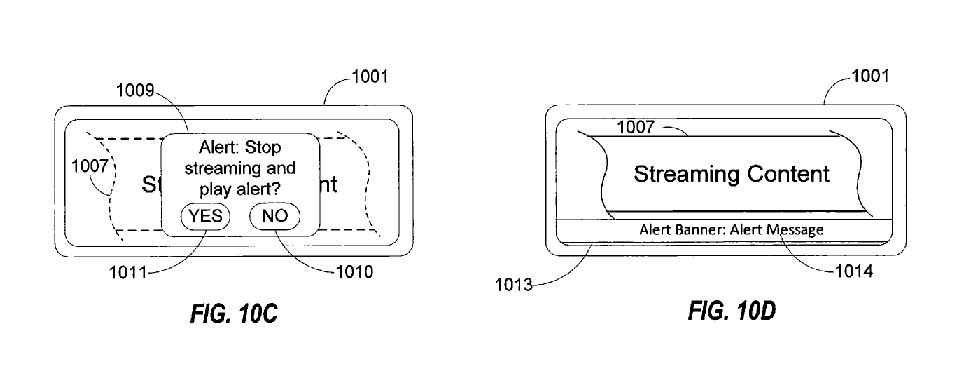

FIG. 10A is a block diagram illustrating a UE 1000 configured according to one aspect of the present disclosure, which is operable to stream content (e.g., eMBMS content) and operable to display concurrent communication services. UE 1000 comprises processor 1003, wireless radio 1005, memory 1004, and display interface 1002, which operate with display 1001 in order to display streaming content to a user, as explained in blocks 801 and 901, and to receive any touch input from a user on display 1001. For example, UE 1000 may receive streaming content 1007 via wireless radio 1005 and buffer the streaming content 1007 in memory 1004. When processor 1003 is ready to process the received streaming content 1007, processor 1003 may retrieve the buffered streaming content 1007 from memory 1004 and process the retrieved data for display. Processor 1003 interfaces with display interface 1002 in order to present the streaming content 1007 on display 1001 to the user. At any point during the streaming of streaming content 1007, the wireless radios 1005 may receive a concurrent communication service from a network entity, as described in blocks 802 and 902. The data in the concurrent communication service may include identity data which identifies the category, rank, priority, classification, type, etc. of the concurrent communication service. ID Logic 1006 of UE 1000 is operable to process the identity data and identify the category, rank, priority, classification, type, etc. of the concurrent communication service using the identity data, while UE 1000 continues to streams the streaming content, as described in blocks 803 and 903.

Additionally and/or alternative, ID Logic 1006 may be operable to independently identify the category, rank, priority, classification, type, etc. of the concurrent communication service based on information other than identity data included in the concurrent communication service. Such an independent identification of the category, rank, priority, classification, type, etc. may be useful for concurrent communication services which lack identity data. Independent identification may also be useful to verify that the data included in a concurrent communication service accurately identified by the identification data included in the concurrent communication service. The independent identification may also be useful to verify and/or authenticate the source from which the concurrent communication service originated and/or was received.

Based on the identifying determination, UE 1000 will determine how to present the concurrent communication service to the user, as explained in blocks 804 and 904. For example, in selected alternative aspects of the present disclosure, UE 1000 may utilize optional table 1008 to determine the proper presentation of the concurrent communication service. Table 1008, which may be stored in memory 1004, is disclosed in the functionality provided in block 904 of FIG. 9. In some aspects of the disclosure, table 1008 may be stored in memory 1004 prior to receiving the concurrent communication service and may be updated from time to time as is desired by a network service provider, CMAS, ETWS, other alert providing entity, user, and/or any combination thereof. In other aspects, table 1008 may be transmitted concurrently with the concurrent communication service. In still other aspects, table 1008 may be populated according to user preferences input by the user, derived from historical user input, and/or any combination thereof. It should be noted that determination block 804 of FIG. 8 is not limited to UE 1000 utilizing a table, but rather, other means of determining how to present the concurrent communication service, or notification thereof, are contemplated by aspects of this disclosure.

Once UE 1000 determines how to present the concurrent communication service to the user, the processor 1003 interfaces with the display interface 1002, to display the concurrent communication service to the user on display 1001, while concurrently streaming the streaming content 1007, as discussed in blocks 805 and 905.

There may be several ways for a UE to present a concurrent communication service to the user. The number and ways of presenting concurrent communication services to a user may change from time to time as is desired by a user, a network entity, a content providing entity, and/or any combination thereof. Examples of manners of presenting a concurrent communication service are described below.

FIG. 10B shows an example manner of presenting concurrent communication services (or notification thereof) wherein a UE pauses the original communication service (e.g., streaming content 1007) being presented on display 1001 and presents a pop-up 1009 associated with one or more concurrent communication services on display 1001. For example, while a UE is streaming and presenting streaming eMBMS content 1007, the UE may pause the presentation of the streaming eMBMS and present the concurrent communication service or a notification of an available concurrent communication service to the user by overlaying a pop-up image 1009 over the paused eMBMS content 1007. When pausing the presentation of the original communication service, the UE may or may not pause the streaming of the original communication service.

In examples where the pop-up 1009 is a notification of an available concurrent communication service, the UE is operable to receive user input indicating the user's desire to be directed to the available concurrent communication service. For example, pop-up 1009 may include a selection option 1010 indicating that the user desires the UE to present the available concurrent communication service on display 1001. If the user selects selection option 1010, then the UE will present the available concurrent communication service on display 1001. As a user touches selection option 1010 on display 1001, display interface 1002 operates to detect the touch and convert the touch data into a signal that processor 1003 may use to display the concurrent communication to the user. Additionally and/or alternatively, if the pop-up 1009 is the concurrent communication service, UE may be operable to receive user input indicating that the user desires to see additional information about the event described in the concurrent communication service. For example, pop-up 1009 may include a selection option 1010 indicating that the user desires the UE to present additional information regarding the event featured in the concurrent communication service on display 1001. If the user, through user input, indicates the desire to see additional information regarding the event featured in the concurrent communication service, then the UE will present additional information regarding the event featured in the concurrent communication service on display 1001.

FIG. 10C shows another example manner of presenting a concurrent communication service involving displaying the concurrent communication service (or notification thereof) and the original communication service at the same time. One manner of concurrently displaying the communications involves moving the presenting of the original communication service (e.g., streaming content 1007) to a background of display 1001 of the UE, while presenting the concurrent communication service (or notification thereof) 1009 in the foreground of display 1001 over the original communication service (e.g., streaming content 1007). During this presentation, both the original communication service 1007 in the background and the concurrent communication service 1009 may be presenting at the same time. For example, while a UE is streaming and presenting streaming eMBMS content, the UE may move the presentation of the streaming eMBMS to the background of the user interface 1001 and present a service alert to the user in the foreground of the user interface 1001 by overlaying a pop-up image 1009 over the presenting and streaming eMBMS content. As such, the user can view two different communications at the same time.

In examples where the pop-up 1009 is a notification of an available concurrent communication service, the UE is operable to receive user input indicating the user's desire to be directed to the available concurrent communication service. For example, pop-up 1009 may include a selection option 1011 indicating that the user desires the UE stop streaming the streaming content (e.g., the original streaming communication) and begin presenting the available concurrent communication on display 1001. If the user selects selection option 1011, the signal detected by display interface 1002 may be used by processor 1003 for the UE to begin presenting the available concurrent communication service. The original communication may be stopped while the available concurrent communication service is presented, but alternatively, the original communication may continue to stream and/or be displayed while the available concurrent communication service is presented.

Additionally and/or alternatively, if the pop-up 1009 is the concurrent communication service (rather than a notification thereof), UE may be operable to receive user input indicating that the user desires to see additional information about the event described in the concurrent communication service. For example, pop-up 1009 may include a selection option 1011 indicating that the user desires the UE to present additional information regarding the event featured in the concurrent communication service on display 1001. If the user makes such an indication to the UE, then the UE displays the additional information.

The UE is also operable to receive user input indicating that the user does not desire to view the concurrent communication service (or notification thereof). For example, if pop-up 1009 is the concurrent communication service or a notification of an available a concurrent communication service, pop-up 1009 may include a selection option 1010, which when selected, indicates that the user does not desire to stop streaming the original communication. If the user selects selection option 1010, the UE stops displaying the pop-up 1009 and streaming content 1007 is brought back to the foreground of display 1001.

Some or all of any pop-up image discussed herein may be translucent if desired allowing the background to be viewed without substantial obstruction. Additionally or alternatively, some or all of any pop-up image discussed herein may be opaque if desired thereby obscuring the background content.

FIG. 10D shows another example manner of presenting a concurrent communication service involving the display of a concurrent communication service 1014 and the original communication service (e.g., streaming content 1007) at the same time by splitting display 1001 to present the original communication service 1007 on a portion of display 1001 while presenting the concurrent communication service message (or notification thereof) 1014 on a different portion of display 1001. As such, the user can view two different communications at the same time without one communication obstructing the other. For example, while a UE is streaming and presenting streaming eMBMS content 1007, the UE may change the resolution of display 1001 in order to apportion part of display 1001 to presenting the streaming eMBMS content 1007 in one portion and display a concurrent communication service message 1014 in a different portion of the display.

The concurrent communication service may be presented as a marquee 1013 or banner which displays at or near the top, bottom, or side of the display 1001. The concurrent communication service message 1014 could display as a split screen presenting on any portion of the screen 1001 as is desired by a user, a network provider, provider entity, and/or any combination thereof. Further, the manner and extent of screen splitting can be contingent on the concurrent communication service's category, rank, priority, classification, type, and/or the like.

Any of the above described pop-up images, marquees, and/or banners may present the user with options. For example, the user may be offered the option to turn off the presenting of the concurrent communication service. If the UE receives input from the user indicating the desire to turn off the presentation of the concurrent communication service, then the UE may turn off the presenting of the concurrent communication service. If the original communication service had been paused when the concurrent communication service was displayed, then the UE may resume presenting of the original communication service. If the original communication service had been moved to the background of the display when the concurrent communication service was displayed, then the UE may resume presenting the original communication service in the foreground of the display. If the original communication service had been moved to a smaller portion of the display when the concurrent communication service was displayed, then the UE may resume presenting the original communication service in the portion of the display within which it is was originally being presented.

Another option that may be presented to the user allows the user to turn off the original communication service. If the UE receives input indicating that the user desires the original communication service be turned off, then the UE can stop presenting the original communication service. Additionally, if desired, the UE can stop streaming the original communication service. When turning off the original communication service, the UE may continue to present the concurrent communication service. If the concurrent communication service is being displayed in a portion of the user interface (e.g., as a pop-up or marquee), the UE may adjust the presentation of the concurrent communication service such that a larger portion (or entire portion) of the display presents the concurrent communication. Further, if the concurrent communication is translucent, the UE may adjust the presentation of the concurrent communication service such that the concurrent communication service is no longer translucent.

In examples, the concurrent communication may be a service alert comprising a concurrent communication service but could also be a service alert comprising notification of an available concurrent communication service. If the service alert comprises the concurrent communication service, then the concurrent communication may present information to the user which alerts the user to a situation. For example, the service alert may provide information about an imitate tornado and give instructions regarding how to handle the situation. The service alert may be text, streaming audio, streaming video, streaming multimedia content, unicast, multicast, eMBMS, and/or the like. The service alert may include an option for the user to receive additional information about the service alert. The service alert may include a link which takes the user to another communication including further information.

If service alert is a notification of an available concurrent communication service, then the notification may present an option for the user to receive the available concurrent communication service. For example, the notification may be included in a SIB, which typically supports a limited about of data, while the available concurrent communication service may be streaming on a different channel (as compared to the SIB on which the notification was received), and when the UE receives user input that the user desires to stream the available concurrent communication service on the different channel, the UE will begin streaming and presenting the available concurrent communication service on the different channel.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and process steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or process described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can include RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or non-transitory wireless technologies, then the coaxial cable, fiber optic cable, twisted pair, DSL, or the non-transitory wireless technologies are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for wireless communication, comprising:
receiving streaming communication content at a mobile device during an active communication session;
presenting the streaming communication content at the mobile device;
receiving an indication, at the mobile device during the active communication session, that a concurrent communication service is available; and
presenting notification of the available concurrent communication service at the mobile device while concurrently streaming the communication content.

2. The method of claim 1, wherein the presenting notification includes:
stopping the presenting of the streaming communication content, in response to receiving the indication, wherein the presenting the notification includes overlaying a pop-up image associated with the available concurrent communication service.

3. The method of claim 2, further including:
presenting an option to a user of the mobile device to turn off the presenting of the notification:
in response to receiving input from the user to turn off the presenting of the notification:
removing the presented notification; and
restarting the presenting of the streaming communication content.

4. The method of claim 1, wherein the presenting notification includes:
moving the presenting of the streaming communication content to a background of a display of the mobile device, wherein the presenting the notification includes overlaying a pop-up image associated with the available concurrent communication service over the streaming communication content presenting in the background.

5. The method of claim 4, further including:
presenting an option to a user of the mobile device to turn off the presenting of the streaming communication content:
in response to receiving input from the user to turn off the presenting of the streaming communication content, stopping the presenting of the streaming communication content.

6. The method of claim 4, further including:
presenting an option to a user of the mobile device to turn off the presenting notification:
in response to receiving input from the user to turn off the presenting notification, stopping the presenting notification.

7. The method of claim 1, wherein the presenting notification includes:
overlaying a pop-up image associated with the notification over a portion of the streaming communication content presenting on the mobile device.

8. The method of claim 7, further including:
presenting an option to a user of the mobile device to turn off the presenting of the streaming communication content:
in response to receiving input from the user to turn off the presenting of the streaming communication content, stopping the presenting of the streaming communication content.

9. The method of claim 7, further including:
presenting an option to a user of the mobile device to turn off the presenting notification:
in response to receiving input from the user to turn off the presenting notification, stopping the presenting notification.

10. The method of claim 1, further including:
identifying a category associated with the available concurrent communication service while concurrently streaming the communication, wherein a presentation manner used in the presenting of the notification is based on the identified category.

11. The method of claim 1, wherein the available concurrent communication service is another streaming content, which is streaming on a different channel as compared to the streaming communication content.

12. A method for wireless communication, including:
streaming communication content, by user equipment (UE);
receiving, from a network service, concurrent content, wherein the receiving is concurrent with the streaming;
identifying, by the UE, while concurrently streaming the streaming content, a category associated with the concurrent content;
based on the identifying, determining, by the UE, how to present the concurrent content to a user, wherein the identifying is concurrent with streaming the streaming content; and
based on the determining, presenting the concurrent content to a user of the UE.

13. The method of claim 12, wherein the presenting includes:
stopping the presenting of the streaming communication content, in response to receiving the concurrent content, wherein the presenting the concurrent content includes overlaying a pop-up image associated with the concurrent content.

14. The method of claim 13, wherein the presenting includes:
presenting an option to a user of the mobile device to turn off the presenting of the concurrent content:
in response to receiving input from the user to turn off the presenting of the concurrent content:
removing the presented concurrent content; and
restarting the presenting of the streaming communication content.

15. The method of claim 12, wherein the presenting includes:
moving the presenting of the streaming communication content to a background of a display of the mobile device, wherein the presenting the concurrent content includes overlaying a pop-up image associated with the concurrent content over the streaming communication content presenting in the background.

16. The method of claim 15, wherein the presenting includes:
presenting an option to a user of the mobile device to turn off the presenting of the streaming communication content:
in response to receiving input from the user to turn off the presenting of the streaming communication content, stopping the presenting of the streaming communication content.

17. The method of claim 15, wherein the presenting includes:
presenting an option to a user of the mobile device to turn off the presenting of the concurrent content:
in response to receiving input from the user to turn off the presenting of the concurrent content, stopping the presenting of the concurrent content.

18. The method of claim 12, wherein the presenting includes:
overlaying a pop-up image associated with the concurrent content over a portion of the streaming communication content presenting on the mobile device.

19. The method of claim 18, wherein the presenting includes:
presenting an option to a user of the mobile device to turn off the presenting of the streaming communication content:
in response to receiving input from the user to turn off the presenting of the streaming communication content, stopping the presenting of the streaming communication content.

20. The method of claim 18, wherein the presenting includes:
presenting an option to a user of the mobile device to turn off the presenting of the concurrent content:
in response to receiving input from the user to turn off the concurrent content, stopping the presenting of the concurrent content.

21. A wireless device for wireless communication, comprising:
a computer processor of a user equipment (UE) operable to receive streaming content; and
a display operable to present the streaming content,
wherein the computer processor of the UE is further operable to receive concurrent content, wherein the concurrent content is received concurrently with the streaming content, and wherein the concurrent content comprises an indication of a category associated with the concurrent content,
wherein the computer processor of the UE is further operable to identify the category, and based on the category, the computer processor of the UE is further operable to determine how to present the concurrent content to a user,
wherein the display is further operable to present the concurrent content according to the computer processor's determination, wherein the display is further operable to concurrently stream the streaming content and present the concurrent content.

22. The wireless device of claim 21, wherein the computer processor is further operable to determine that the concurrent content should be presented by:
stopping the presenting of the streaming content, in response to receiving the concurrent content, wherein the presenting of the concurrent content includes overlaying a pop-up image associated with the concurrent content.

23. The wireless device of claim 21, wherein the computer processor is further operable to determine that the concurrent content should be presented by:
presenting an option to a user of the mobile device to turn off the presenting of the concurrent content:
in response to receiving input from the user to turn off the presenting of the concurrent content, the computer processor is further operable to remove the presenting concurrent content and restart the presenting of the streaming communication content.

24. The wireless device of claim 21, wherein the computer processor is further operable to determine that the concurrent content should be presented by:
moving the presenting of the streaming communication content to a background of a display of the mobile device, wherein the presenting of the concurrent content includes overlaying a pop-up image associated with the concurrent content over the streaming communication content presenting in the background.

25. The wireless device of claim 24, wherein the computer processor is further operable to determine that the concurrent content should be presented by:
presenting an option to a user of the mobile device to turn off the presenting of the streaming communication content:
in response to receiving input from the user to turn off the presenting of the streaming communication content, stopping the presenting of the streaming communication content.

26. The wireless device of claim 24, wherein the computer processor is further operable to determine that the concurrent content should be presented by:
presenting an option to a user of the mobile device to turn off the concurrent content:
in response to receiving input from the user to turn off the presenting of the concurrent content, the computer processor is further operable to stop the presenting of the concurrent content.

27. The wireless device of claim 21, wherein the computer processor is further operable to determine that the concurrent content should be presented by:
overlaying a pop-up image associated with the concurrent content over a portion of the streaming communication content presenting on the mobile device.

28. The wireless device of claim 27, wherein the computer processor is further operable to determine that the concurrent content should be presented by:
presenting an option to a user of the mobile device to turn off the presenting of the streaming communication content:
in response to receiving input from the user to turn off the presenting of the streaming communication content, the computer processor is further operable to stop the presenting of the streaming communication content.

29. The wireless device of claim 27, wherein the computer processor is further operable to determine that the concurrent content should be presented by:
presenting an option to a user of the mobile device to turn off the presenting of the concurrent content:
in response to receiving input from the user to turn off the presenting of the concurrent content, wherein the computer processor is further operable to stop the presenting of the concurrent content.

30. A wireless communication system of a user equipment (UE), comprising:
means for receiving streaming content;
means for receiving concurrent content, wherein the receiving is concurrent with the receiving the streaming content;
means for identifying, while concurrently receiving the streaming content, a category associated with the concurrent content;
based on the identifying, means for determining how to present the concurrent content to a user, wherein the identifying is concurrent with the streaming content; and
based on the determining, means for presenting the concurrent content to a user of the UE.

31. The system of claim 30, wherein the presenting includes:
means for stopping the presenting of the streaming communication content, in response to receiving the concurrent content, wherein the presenting the concurrent content includes overlaying a pop-up image associated with the concurrent content.

32. The system of claim 31, wherein the presenting includes:
means for presenting an option to a user of the mobile device to turn off the presenting of the concurrent content:
in response to receiving input from the user to turn off the presenting of the concurrent content:
means for removing the presented concurrent content; and
means for restarting the presenting of the streaming communication content.

33. The system of claim 30, wherein the presenting includes:
means for moving the presenting of the streaming communication content to a background of a display of the mobile device, wherein the presenting the concurrent content includes overlaying a pop-up image associated with the concurrent content over the streaming communication content presenting in the background.

34. The system of claim 33, wherein the presenting includes:
means for presenting an option to a user of the mobile device to turn off the presenting of the streaming communication content:
in response to receiving input from the user to turn off the presenting of the streaming communication content, means for stopping the presenting of the streaming communication content.

35. The system of claim 33, wherein the presenting includes:
means for presenting an option to a user of the mobile device to turn off the presenting of the concurrent content:
in response to receiving input from the user to turn off the presenting of the concurrent content, means for stopping the presenting of the concurrent content.

36. The system of claim 30, wherein the presenting includes:
means for overlaying a pop-up image associated with the concurrent content over a portion of the streaming communication content presenting on the mobile device.

37. The system of claim 36, wherein the presenting includes:
means for presenting an option to a user of the mobile device to turn off the presenting of the streaming communication content:
in response to receiving input from the user to turn off the presenting of the streaming communication content, means for stopping the presenting of the streaming communication content.

38. The system of claim 36, wherein the presenting includes:
means for presenting an option to a user of the mobile device to turn off the presenting of the concurrent content:
in response to receiving input from the user to turn off the concurrent content, means for stopping the presenting of the concurrent content.

39. A non-transitory computer-readable medium of a user equipment (UE) having program code stored thereon, wherein the program code, when executed by a computer, causes the computer to:
present streaming content;
receive concurrent content, wherein the receiving is concurrent with the streaming;
identify, while concurrently streaming the streaming content, a category associated with the concurrent content;
based on the identifying, determine how to present the concurrent content to a user, wherein the determination is determined concurrently with streaming the streaming content; and
based on the determining, present the concurrent content to a user of the UE.

40. The non-transitory computer-readable medium of claim 39, wherein the presenting includes:
stopping the presenting of the streaming content, in response to receiving the concurrent content, wherein the presenting the concurrent content includes overlaying a pop-up image associated with the concurrent content.

41. The non-transitory computer-readable medium of claim 40, wherein the presenting includes:
presenting an option to a user of the mobile device to turn off the presenting of the concurrent content:
in response to receiving input from the user to turn off the presenting of the concurrent content:
removing the presented concurrent content; and
restarting the presenting of the streaming communication content.

42. The non-transitory computer-readable medium of claim 39, wherein the presenting includes:
moving the presenting of the streaming content to a background of a display of the mobile device, wherein the presenting the concurrent content includes overlaying a pop-up image associated with the concurrent content over the streaming content presenting in the background.

43. The non-transitory computer-readable medium of claim 42, wherein the presenting includes:
presenting an option to a user of the mobile device to turn off the presenting of the streaming content:
in response to receiving input from the user to turn off the presenting of the streaming content, stopping the presenting of the streaming content.

44. The non-transitory computer-readable medium of claim 42, wherein the presenting includes:
presenting an option to a user of the mobile device to turn off the presenting of the concurrent content:
in response to receiving input from the user to turn off the presenting of the concurrent content, stopping the presenting of the concurrent content.

45. The non-transitory computer-readable medium of claim 39, wherein the presenting includes:
overlaying a pop-up image associated with the concurrent content over a portion of the streaming content presenting on the mobile device.

46. The non-transitory computer-readable medium of claim 45, wherein the presenting includes:
presenting an option to a user of the mobile device to turn off the presenting of the streaming content:
in response to receiving input from the user to turn off the presenting of the streaming content, stopping the presenting of the streaming content.

47. The non-transitory computer-readable medium of claim 45, wherein the presenting includes:
presenting an option to a user of the mobile device to turn off the presenting of the concurrent content:
in response to receiving input from the user to turn off the concurrent content, stopping the presenting of the concurrent content.
